(19) United States
(12) Patent Application Publication
(10) Pub. No.: US 2009/0060717 A1
(43) Pub. Date: Mar. 5, 2009

(54) SYNCHRONOUS SIGNAL GENERATOR FOR TRIM BALANCING OF JET ENGINE

(75) Inventors: Mark A. Shilo, Scottsdale, AZ (US); Paul B. Talbert, Phoenix, AZ (US); Mohsiul Alam, Chandler, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/769,515

(22) Filed: Jun. 27, 2007

(51) Int. Cl. F01D 25/04; G01M 1/22; G01B 7/00

(52) U.S. Cl. 415/119; 73/462; 324/207.13

(57) ABSTRACT

A synchronous signal generator is provided for use in conjunction with an aircraft engine having a spool and an engine output shaft driven by the spool. The synchronous signal generator includes a generator housing, a generator output member rotatably mounted in the generator housing, a once-per-revolution timing mark on the generator output member, and conversion gearing disposed within the housing and configured to couple the engine output shaft to the generator output member. The conversion gearing rotates the generator output member at substantially the same rotational frequency as the spool when the conversion gearing is coupled to the engine output shaft.

### FIELD OF THE INVENTION

The present invention relates generally to jet engines, and, more particularly, to a synchronous signal generator for use in the trim balancing of a multi-spool aircraft engine.

### BACKGROUND OF THE INVENTION

A multi-spool jet engine (e.g., a turbofan engine) typically includes a high pressure (HP) spool, which supports a high pressure compressor and a high pressure turbine. The high pressure compressor and the high pressure turbine may each include one or more bladed discs that extend radially outward from the HP shaft. As the HP shaft rotates, so too do the bladed discs. If the discs are not properly balanced (i.e., if the mass of the discs is not evenly distributed about the longitudinal axis of the HP shaft), vibrations may be produced as the HP shaft rotates.

To decrease or eliminate vibrations, the bladed discs forming the high pressure turbine and those forming the high pressure compressor may be balanced individually or simultaneously. In general, trim balancing involves the addition of weight to (e.g., the attachment of a counterweight) or the removal of weight from (e.g., grinding) the HP spool, the high pressure turbine, and/or the high pressure compressor. Typically, multiple trial runs are performed. During each trial run, a test weight is added to the HP shaft at a chosen location and the resulting change in the magnitude of vibration is recorded. These changes in vibrations are then correlated to the rotational frequency of the HP spool during each trial run, and the location at which weight should be added or removed is eventually determined.

When the jet engine is assembled, the HP shaft is contained within the engine's nacelle; it is thus difficult to directly measure the rotational frequency and position of the HP shaft during the trim balancing trial runs. Electronic signal generators have been developed that may derive the rotational frequency of the HP shaft by monitoring the rotation of a gear or other rotational body mechanically coupled to the HP shaft. Such a signal generator may include a controller having a sensor (e.g., a monopole or a proximity sensor), which is coupled to the controller and positioned adjacent the gear. As the gear rotates, each tooth of the gear passes by the sensor, which produces a corresponding timing pulse. The controller utilizes the signal provided by the sensor to derive the rotational frequency of the HP shaft during the trial run, which may then be utilized to trim balance the jet engine in the manner described above.

In conventional signal generators of the type described above, the sensor produces multiple timing pulses for each revolution of the HP shaft. The controller cannot determine which of these pulses represents a full revolution of the HP shaft through multiple trial runs. As a result, the timing pulse may become unsynchronized with the HP spool between engine starts during the trim balancing process. Due to this asynchronization, it may be difficult to determine the proper location at which weight should be added or removed without the performance of a significant number of trial runs; e.g., utilizing conventional trim balancing techniques and equipment, eight trial runs are typically necessary for two plan trim balancing. During each trial run, the engine is shut-down, dissembled, reassembled, and then re-activated. The performance of multiple trial runs is thus time consuming and costly. In addition, each trial run results in additional wear to the jet engine consequently decreasing the engine's life and overall value.

Considering the foregoing, it should be appreciated that it is desirable to provide a synchronous signal generator that produces a signal indicative of the rotational frequency of an aircraft spool (e.g., the high pressure spool) and that remains synchronized with the spool throughout the trim balancing process. Other desirable features and characteristics of the present invention will become apparent from the subsequent detailed description of the invention and the appended claims, taken in conjunction with the accompanying drawings and this background of the invention.

### BRIEF SUMMARY OF THE INVENTION

A synchronous signal generator is provided for use in conjunction with an aircraft engine having a spool and an engine output shaft driven by the spool. The synchronous signal generator includes a generator housing, a generator output member rotatably mounted in the generator housing, a once-per-revolution timing mark on the generator output member, and conversion gearing disposed within the housing and configured to couple the engine output shaft to the generator output member. The conversion gearing rotates the generator output member at substantially the same rotational frequency as the spool when the conversion gearing is coupled to the engine output shaft.

### BRIEF DESCRIPTION OF THE DRAWINGS

The present invention will hereinafter be described in conjunction with the following drawing figures, wherein like numerals denote like elements, and:

FIGS. 1 and 2 are cross-sectional and isometric views, respectively, of a conventional multi-spool jet engine including an accessory gearbox;

FIGS. 3 and 4 are side cross-sectional and rear cross-sectionals, respectively, of a simplified synchronous signal generator in accordance with a first exemplary embodiment of the present invention; and

FIG. 5 is a functional schematic of the exemplary synchronous signal generator shown in FIGS. 3 and 4 coupled to the multi-spool jet engine shown in FIGS. 1 and 2.

### DETAILED DESCRIPTION OF AT LEAST ONE EXEMPLARY EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. In this regard, although a three spool turbofan gas turbine engine is described for illustrative purposes below, it will be appreciated that the invention may be utilized with other types of multi-spool aircraft engine.

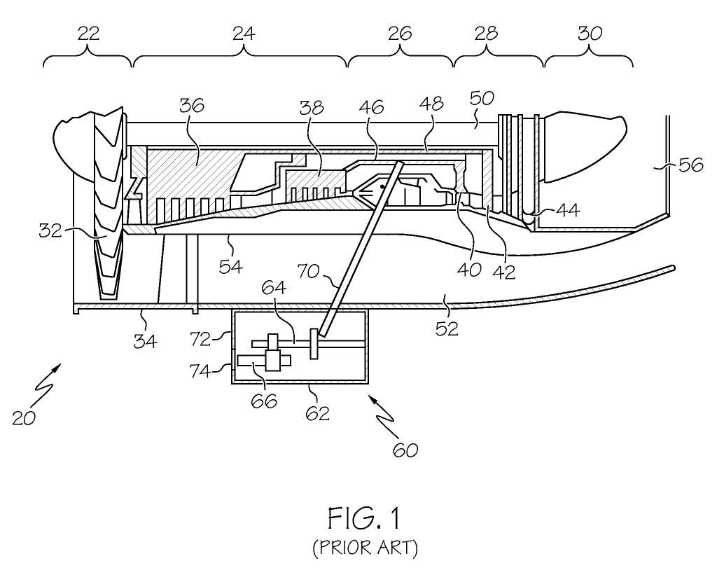

FIGS. 1 and 2 are cross-section and isometric views of a multi-spool jet engine 20 of the type conventionally deployed on an aircraft. In this particular example, multi-spool jet engine 20 is a three spool turbofan gas turbine engine. As shown in FIG. 1, jet engine 20 may have an intake section 22, a compressor section 24, a combustion section 26, a turbine section 28, and an exhaust section 30. Intake section 22 includes a fan 32, which is mounted in a fan case 34. Compressor section 24 includes one or more compressors (e.g., an intermediate pressure (IP) compressor 36 and a high pressure (HP) compressor 38), and turbine section 28 includes one or more turbines (e.g., an HP turbine 40, an IP turbine 42, and a low pressure (LP) turbine 44), which may be disposed in axial flow series. HP compressor 38 and HP turbine 40 are mounted on opposite ends of an HP shaft or spool 46; IP compressor 36 and IP turbine 42 are mounted on opposite ends of IP spool 48; and fan 32 and LP turbine 44 are mounted on opposite ends of a LP spool 50. HP spool 46, IP spool 48, and LP spool 50 are substantially co-axial. That is, LP spool 50 may extend through a longitudinal channel provided through IP spool 48, and IP spool 48 may extend through a longitudinal channel provided through HP spool 46.

During operation of jet engine 20, air is drawn into intake section 22 and accelerated by fan 32. A portion of this accelerated air is directed through a bypass section 52 disposed between fan case 34 and an engine cowl 54 to provide forward thrust. The remaining portion of air exhausted from fan 32 is directed into compressor section 24 and compressed by IP compressor 36 and HP compressor 38. The compressed air then flows into combustion section 26 wherein the air is mixed with fuel and combusted. The combusted air expands rapidly and flows through turbine section 28 thereby rotating turbines 40, 42, and 44. The rotation of turbines 40, 42, and 44 (and, therefore, of spools 46, 48, and 50) drives the rotation of HP compressor 38, IP compressor 36, and fan 32, respectively. Finally, after passing through turbine section 28, the air is exhausted through a propulsion nozzle 56 mounted in exhaust section 30 to provide addition forward thrust.

Jet engine 20 is further provided with an engine output shaft, which may be any body that is rotatably coupled to HP spool 46. As a non-limiting example, the engine output shaft may be a gearbox output shaft contained within a conventional accessory gearbox. To further illustrate this point, FIGS. 1 and 2 depict jet engine 20 as having an accessory gearbox 60 mounted to the lower structure of jet engine 20. Accessory gearbox 60 includes a gearbox housing 62, which contains a gearbox input shaft 64 and at least one gearbox output shaft 66 (e.g., a female spline). Gearbox output shaft 66 is rotationally coupled to gearbox input shaft 64, which is rotationally coupled to HP spool 46 by way of a tower shaft 70. When HP spool 46 rotates, tower shaft 70 drives gearbox input shaft 64, which, in turn, drives gearbox output shaft 66. Gearbox output shaft 66 thus rotates in conjunction with HP spool 46. However, the rotational frequency of gearbox output shaft 66 will not be equivalent to that of HP spool 46; instead, relative to the rotational frequency of HP spool 46, the rotational frequency of gearbox output shaft 66 will be reduced by the gear ratio from HP spool 46 to gearbox output shaft 66. For example, if the gear ratio is 3.5:1, HP spool 46 will rotate three and a half revolutions for each revolution of gearbox output shaft 66.

At least one accessory flange or pad 72 is provided on the exterior of gearbox housing 62. As indicated in FIG. 2, an accessory 76 (e.g., a generator, a hydraulic pump, etc.) may be mounted (e.g., bolted to) on pad 72 after engine 20 has been installed on an aircraft. Accessory 76 includes a rotatable shaft 78 (e.g., a male spline), which may be inserted into gearbox housing 62 through an aperture 74 provided in gearbox housing 62. When inserted through aperture 74, rotatable shaft 78 mechanically engages gearbox output shaft 66. Thus, when jet engine 20 is activated, HP spool 46 drives gearbox output shaft 66, which, in turn, drives rotatable shaft 78 of accessory 76.

HP turbine 40 and HP compressor 38 each include one or more bladed discs, which are fixedly mounted on HP spool 46 and rotate therewith. If these bladed discs are not properly balanced, vibrations may be produced as HP spool 46 rotates. To minimize or eliminate these vibrations, the bladed discs forming HP turbine 40 and those forming compressor 38 may be trim balanced by adding or removing weight from HP turbine 40, HP compressor 38, and/or HP spool 46. As explained above, the vibrations produced by engine 20 may be measured during a number of trial runs and then compared to the rotational frequency of HP spool 46 during each trial run to determine the locations at which weight should be added or removed. Although electronic devices exist that produce a synchronous timing pulse indicative of the rotational frequency of an HP spool during a given trial run, the timing pulse becomes asynchronous between successive trial runs. The following describes one example of signal generator that produces a signal indicative of the rotational frequency and position of HP spool 46 that remains synchronized with HP spool 46 over an infinite number of trial runs and thereby facilitates the trim balancing process.

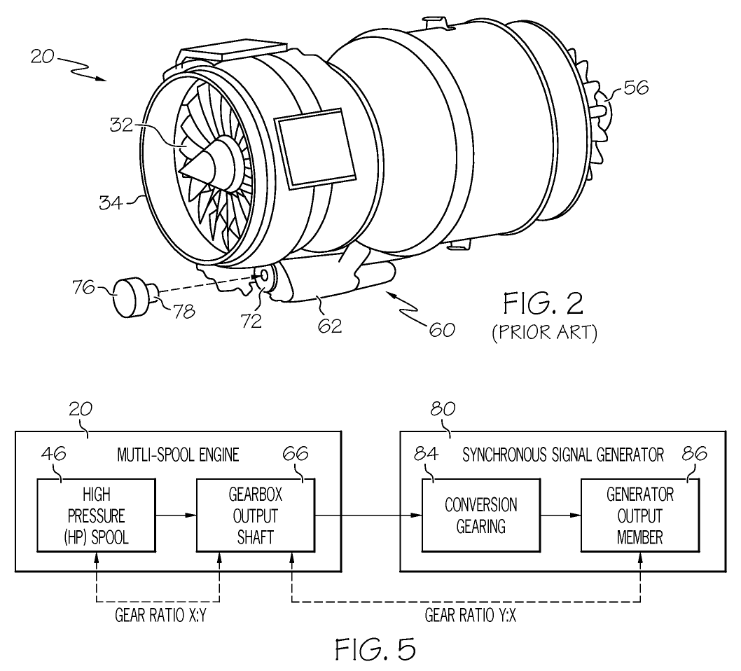

FIGS. 3 and 4 are simplified side cross-sectional and rear cross-sectional views, respectively, of a synchronous signal generator 80 in accordance with a first exemplary embodiment. Signal generator 80 includes a housing 82, which houses conversion gearing 84 (e.g., a gear train) and a generator output member 86 (e.g., a geared shaft). Generator output member 86 is mechanically coupled to, and thus rotates in conjunction with, conversion gearing 84. Conversion gearing 84 includes one or more rotational bodies suitable for indirectly coupling generator output member 86 to HP spool 46; e.g., conversion gearing 84 may be a gear train, which is configured to be mechanically coupled to gearbox output shaft 66 in the manner described below. In the illustrated exemplary embodiment, conversion gearing 84 includes first and second geared shafts 88 and 90. Geared shafts 88 and 90 are each rotatably mounted in housing 82. For example, in the case of geared shaft 88, a first bearing assembly 92 (e.g., an annular roller bearing) may be disposed around an intermediate portion of geared shaft 88 and a second bearing assembly 94 (e.g., an annular ball bearing) may be disposed around an end portion of geared shaft 88. Similar bearing assemblies may also be disposed around geared shaft 90 and/or generator output member 86, although such bearing assemblies are not shown in FIGS. 3 and 4 for clarity.

Conversion gearing 84 is configured to be mechanically coupled to HP spool 46 via accessory gearbox 60 (FIG. 2). For example, geared shaft 88 may include a threaded or toothed protruding portion 96 (e.g., a male or female spline) that may extend from housing 82. Synchronous signal generator 80 may be mounted (e.g., bolted) onto accessory pad 72 (FIGS. 1 and 2) prior to installation of (or after the removal of) accessory 76 (FIG. 2). When synchronous signal generator 80 is mounted to accessory pad 72, protruding portion 96 extends through aperture 74 (FIG. 1) and mechanically engages gearbox output shaft 66 (e.g., a female or male spline). Thus, when synchronous signal generator 80 is installed in this manner, generator output member 86 is coupled and rotates in conjunction with conversion gearing 84 and, therefore, HP spool 46.

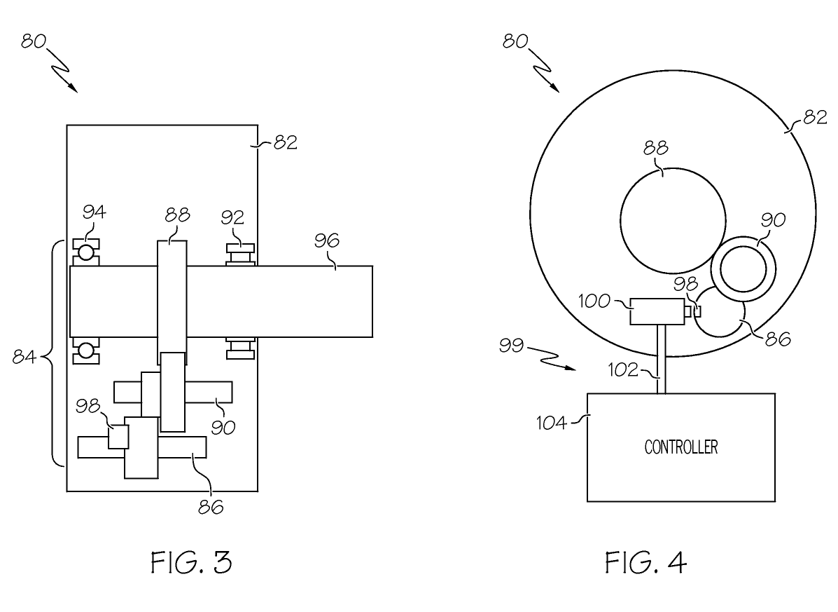

Synchronous signal generator 80 is configured such that the rotational frequency of generator output member 86 is substantially equivalent to that of HP spool 46. This point is further illustrated in FIG. 5, which is a functional schematic of signal generator 80 coupled to gearbox output shaft 66 of multi-spool engine 20. As stated above, the rotational frequency of gearbox output shaft 66 (RF_{gearbox}_{_{—}}ₒᵤₜₚᵤₜ_{_{—}}_{shaft}) is related to the rotational frequency of HP spool 46. In particular, RF_{gearbox}_{_{—}}ₒᵤₜₚᵤₜ_{_{—}}_{shaft} is a function of the gear ratio taken from HP spool 46 to gearbox output shaft 66. This gear ratio is determined by the design of jet engine 20 and may vary from engine to engine. Thus, for purposes of illustration, the HP-spool-to-gearbox-output-shaft gear ratio will be referred to generically as X:Y. Conversion gearing 84 is configured such that the gear ratio taken from gearbox output shaft 66 to generator output member 86 is substantially the inverse of the gear ratio taken from HP spool 46 to gearbox output shaft 66. That is, conversion gearing 84 is configured to produce a gearbox-ouput-shaft-to-generator-ouput-member gear ratio of substantially Y:X. Thus, if the HP-spool-to-gearbox-output gear is, for example, 3.2:1, conversion gearing 84 will preferably be configured to produce a gearbox-output-shaft-to-generator-output-member gear ratio of substantially 1:3.2. In this manner, conversion gearing 84 may be configured such that generator output member 86 rotates at substantially the same frequency as does HP spool 46 (i.e., the gear ratio taken from HP spool 46 to generator output member 86 is substantially X:X or 1:1).

A once-per-revolution timing mark 98 is provided on generator output member 86. Once-per-revolution timing mark 98 may be any element that may be monitored to produce a timing signal indicating the rotational frequency of output member 86 and, therefore, of HP spool 46. In one option, once-per-revolution timing mark 98 may be a topographical feature formed on the shaft of generator output member 86, such as a cavity (e.g., a notch) or a projection (e.g., a keyway). In another option, once-per-revolution timing mark 98 may be an optical feature, such as a surface (e.g., reflective tape) having unique light-absorbing or reflecting characteristics relative to the surrounding portions of output member 86. As shown in FIG. 4, the rotation of once-per-revolution timing mark 98 may be monitored electronically by a sensor system 99 disposed proximate generator output member 86. In the illustrated exemplary embodiment, sensor system 99 includes a probe or sensor 100, which may be coupled by way of connector 102 to a sensor controller 104. Sensor 100 may take the form of any electronic device capable of monitoring the movement of timing mark 98 (e.g., identifying when timing mark 98 passes by sensor 100). Thus, if timing mark 98 is a topographical feature formed in or on a metal body, and sensor 100 may be an induction probe (e.g., monopole or a proximity probe). Alternatively, if timing mark 98 is a strip of reflective tape, and sensor 100 may be a light source (e.g., a laser, a light emitting diode, etc.) and a light sensor. Regardless of their particular form, once-per-revolution timing mark 98 and sensor 100 cooperate to produce a timing pulse corresponding to each revolution of generator output member 86 and, therefore, to each revolution of HP spool 46. As will be appreciated by one of ordinary skill in the art, the timing pulses produced by sensor 100 may be utilized by controller 104 or other conventional vibration measuring equipment to determine the location at which weight should be added or removed from HP turbine 40, HP compressor 38, and/or HP spool 46.

It should be appreciated from the foregoing that conversion gearing 84 substantially matches the rotational frequency of generator output member 66 to that of HP spool 46. It should also be appreciated that generator output member 66 is mechanically locked to HP spool 46 (e.g., even if HP spool 46 were to be manually moved by a technician inspecting HP turbine 40, generator output shaft 66 will move accordingly). For these reasons, generator output member 66, and thus the timing pulses produced by sensor 100, will remain synchronized with HP spool 46 for an infinite number of trial runs. As a result, jet engine 20 may be trim balanced utilizing a minimum number of trial runs (e.g., one plane trim balancing may be performed with a single trial run, and two plane trim balancing may be performed with a total of two trial runs). Synchronous signal generator 80 thus facilitates the trim-balancing of high speed (or intermediate speed) shafts that do not have a synchronous timing mark available.

Although the foregoing has described an exemplary synchronous signal generator that may be retrofitted onto a multi-spool jet engine, it should be understood that the signal generator may be incorporated into the engine. Furthermore, to provide compatibility with engines having variety of spool-to-gearbox-output-shaft gear ratios, the synchronous signal generator may be configured to permit the gear ratio of the conversion gearing to be manipulated (e.g., the conversion gearing may be interchangeable). Note also that the synchronous signal generator may be utilized to trim balance any suitable spool, including, for example, an intermediate pressure spool (e.g., IP spool 50 shown in FIG. 1). While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A synchronous signal generator for use in conjunction with an aircraft engine having a spool and an engine output shaft driven by the spool, the synchronous signal generator comprising:
a generator housing;
a generator output member rotatably mounted in the generator housing;
a once-per-revolution timing mark on the generator output member; and
conversion gearing disposed within the housing and configured to couple the engine output shaft to the generator output member, the conversion gearing rotating the generator output member at substantially the same rotational frequency as the spool when the conversion gearing is coupled to the engine output shaft.

2. A synchronous signal generator according to claim 1 wherein the aircraft engine includes an accessory gearbox containing at least a portion of the engine output shaft, the generator housing configured to be mounted onto the accessory gearbox.

3. A synchronous signal generator according to claim 2 wherein the conversion gearing includes a protruding portion extending from the generator housing, the protruding portion configured to coupled to the engine output member.

4. A synchronous signal generator according to claim 3 wherein the protruding portion comprises a first spline, and the engine output member comprises a second spline configured to engage the first spline.

5. A synchronous signal generator according to claim 1 wherein the synchronous signal generator further comprises a sensor system disposed proximate the generator output member and configured to monitor the rotation thereof via the once-per-revolution timing mark.

6. A synchronous signal generator according to claim 5 wherein the sensor system comprises:
a sensor positioned proximate the generator output member and configured to monitor the rotation thereof via the once-per-revolution timing mark; and
a controller operatively coupled to the sensor.

7. A synchronous signal generator according to claim 6 wherein the sensor is selected is a probe selected from a group consisting of a proximity probe, a monopole, and a light probe.

8. A synchronous signal generator according to claim 1 wherein the once-per-revolution timing mark comprises a topographical feature formed on the generator output member.

9. A synchronous signal generator according to claim 8 wherein the once-per-revolution-timing mark is a keyway.

10. A synchronous signal generator according to claim 1 wherein the once-per-revolution timing mark comprises an optical feature.

11. A synchronous signal generator for use in conjunction with an aircraft engine having a spool and an engine output shaft driven by the spool, the spool-to-engine-output-shaft gear ratio being X:Y, the synchronous signal generator comprising:
a generator housing;
a generator output member rotatably mounted in the generator housing;
a once-per-revolution timing mark on the generator output member; and
conversion gearing disposed within the housing and mechanically coupling the generator output member to the engine output shaft, the conversion gearing configured to produce an engine-output-shaft-to-generator-output-member gear ratio of substantially Y:X.

12. A synchronous signal generator according to claim 11 wherein the engine includes an accessory gearbox containing at least a portion of the engine output shaft, the synchronous signal generator configured to be mounted on the accessory gearbox.

13. A synchronous signal generator according to claim 11 wherein the conversion gearing is configured matingly engage the accessory gearbox output shaft.

14. A synchronous signal generator according to claim 11 wherein the synchronous signal generator further comprises:
a sensor positioned proximate the generator output member and configured to monitor the rotation thereof via the once-per-revolution timing mark; and
a controller operatively coupled to the sensor.

15. A synchronous signal generator according to claim 14 wherein the once-per-revolution timing mark comprises a physical feature formed on the generator output member, and wherein the sensor comprises a proximity probe.

16. A synchronous signal generator according to claim 14 wherein the once-per-revolution timing mark comprises a physical feature formed on the generator output member, and wherein the sensor comprises a monopole.

17. A synchronous signal generator according to claim 14 wherein the once-per-revolution timing mark comprises a reflective tape disposed on the generator output member, and wherein the sensor comprises a light source and light sensor.

18. A synchronous signal generator for use in conjunction with an aircraft engine having a high pressure spool, an accessory gearbox, and a gearbox output shaft coupled to the high pressure spool, the synchronous signal generator comprising:
a generator housing configured to be mounted on the accessory gearbox;
a generator output member rotatably mounted in the generator housing;
a once-per-revolution timing mark disposed on the generator output member;
a gear train disposed within the housing and configured to matingly engage the gearbox output shaft when the generator housing is mounted on the accessory gearbox, the gear train configured to rotate the generator output member at substantially the same rotational frequency as the high pressure spool; and
a sensor system disposed proximate the generator output member and configured to monitor the rotation thereof via the once-per-revolution timing mark and generate a timing pulse synchronized with the rotation of the high pressure spool.

19. A synchronous signal generator according to claim 18 wherein the once-per-revolution timing mark comprises a topographical feature on the generator output member.

20. A synchronous signal generator according to claim 19 wherein the sensor system includes an induction probe positioned proximate the generator output member and configured to monitor the rotation of the once-per-revolution timing mark.
